(19) United States
(12) Patent Application Publication
(10) Pub. No.: US 2008/0265675 A1
(43) Pub. Date: Oct. 30, 2008

(54) External transformation socket

(76) Inventor: Yu-Lin Peng, Sijhih City (TW)

Correspondence Address: TROXELL LAW OFFICE PLLC, SUITE 1404, 5205 LEESBURG PIKE, FALLS CHURCH, VA, 22041, US

(21) Appl. No.: 11/797,096

(22) Filed: Apr. 30, 2007

(51) Int. Cl. H02J 3/14; H02J 1/00; H02J 3/00

(52) U.S. Cl. 307/31; 307/73

(57) ABSTRACT

An external transformation socket without a power cord is disclosed, which includes an AC or DC power input, a transformer and an AC or DC power output. The functions of inputting, transforming and outputting include AC/AC, AC/DC, DC/DC, and DC/AC. The circuit board of the socket thereon includes an AC/DC power input, transformation coils, a capacitor, a constant voltage regulator, and many groups of AC/DC outputs with different voltages and currents after being transformed. Thereby, power may be supplied and output via various AC/DC outputs, depending on DC or AC requirements for users.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of the Invention

The present invention relates to an eternal transformation socket having an AC or DC power input, a transformer and an AC or DC power output. The structure thereof comprises a socket, which inputs power from the AC/DC input, and outputs power via various outputs with different voltages and currents after being transformed.

2. Background of the Invention

Recently, electronic products have been developed rapidly due to the diligence of the related manufacturers and engineers. Particularly, the products associated with information and communication are changed and advanced so effectively that manifold peripherals with different functions, such as printers, notebook computers, scanners, external disks, hubs, card readers, digital cameras, speakers, MP3, video network, wireless keyboards, wireless mice, chargers for cellular phones, PDF, etc., are successively utilized in the application of computer information, communication and audiovisual products.

Such computer peripherals, communication equipment or audiovisual products, especially for DC power applications, almost all need power sufficient for operation.

As is known, power is provided for these computer peripherals, communication equipment or audiovisual products by connecting a power cord having a transformer at one end to a common AC socket, transforming alternating current into direct current through the transformer, and supplying the same for those in use. Or, power is provided by equipping with a rechargeable battery able to accumulate charge, and electrifying the rechargeable battery to supply power after it is transformed by the transformer.

Either in the case where alternating current or direct current is converted into DC power or in the case where DC power is transformed to be at correct voltage and current, there will be lots of transformers and plugs when the AC power cords are connected to the socket or DC socket. Also, the power cords connected to the peripherals cross one another, so as to form a complex network. Moreover, the transformer is essential for the charger of the rechargeable battery to be electrified.

Furthermore, the potential standards may be different between countries, such as 220 volts (V) or 110V. Hence, the electronic products adapted to AC power still need to be transformed before use. It is not convenient for travelers since they have to carry various transformers.

It is another condition where the electronic products are adapted to AC power but only DC power can be used then. For example, a vacuum cleaner, light or audio adapted to AC power is used in a car. Therefore, there is a need to transform direct current into alternating current.

The deficiency in conventional power supply systems is apparent during the transformation or conversion of AC/AC, AC/DC, DC/DC, or DC/AC. Hence, the “external transformation socket” is provided here based on the Applicant's experiments of developing computer related products and power supply systems for years.

### SUMMARY OF THE INVENTION

Referring to FIGS. 1-8, the external transformation socket provided herein is a portable socket without power cords, and having AC or DC inputs and many groups of transformed AC or DC outputs. The functions of inputting, transforming and outputting include AC/AC, AC/DC, DC/DC, and DC/AC.

The external transformation socket comprises a substrate 1, a circuit board 2 fixed on the substrate 1, as well as a top housing 3.

### BRIEF DESCRIPTION OF THE DRAWINGS

FIG. 1 shows a stereo-diagram of a socket with a DC power input and a DC power output according to one embodiment of the invention.

FIG. 2 shows a perspective and exploded diagram of a socket with a DC power input and a DC power output according to one embodiment of the invention.

FIG. 3 shows a stereo-diagram of a socket with an AC power input and an AC power output according to one embodiment of the invention.

FIG. 4 shows a perspective and exploded diagram of a socket with an AC power input and an AC power output according to one embodiment of the invention.

FIG. 5 shows a stereo-diagram of a socket with an AC power input and an AC power output according to one embodiment of the invention.

FIG. 6 shows a perspective and exploded diagram of a socket with an AC power input and an AC power output according to one embodiment of the invention.

FIG. 7 shows a stereo-diagram of a socket with a DC power input and a DC power output according to one embodiment of the invention.

FIG. 8 shows a perspective and exploded diagram of a socket with a DC power input and a DC power output according to one embodiment of the invention.

### DETAILED DESCRIPTION OF SOME EMBODIMENTS

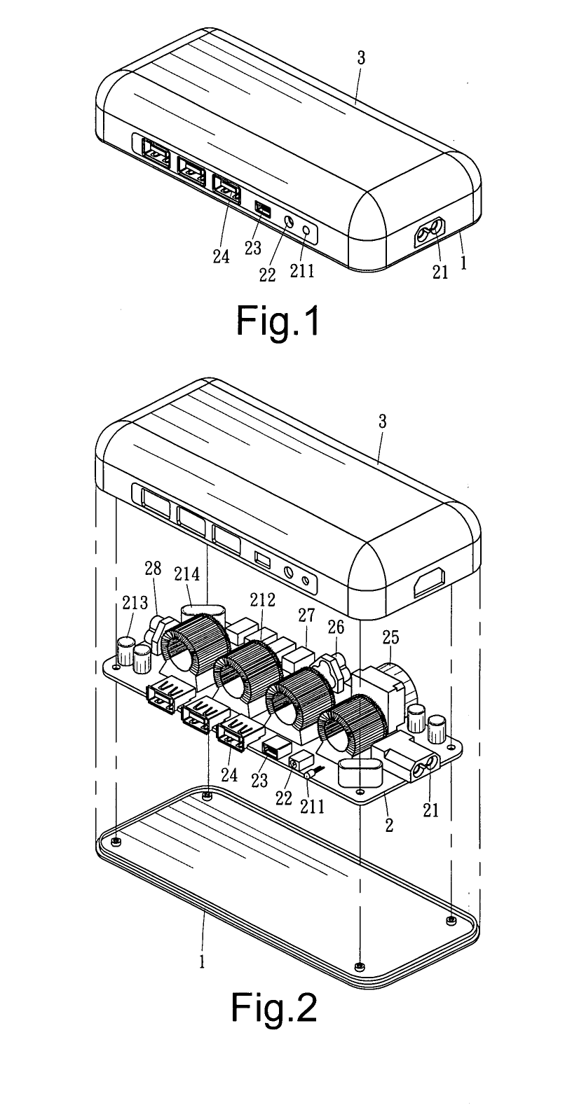

FIGS. 1 through 8 illustrate the external transformation socket in accordance with the invention; wherein the circuit board 2 includes a direct current (DC) power input 21 or alternating current (AC) power input 21A, an indicator 211, a transformation coil 212, a capacitor 213, a constant voltage regulator 214, and several DC outputs 22, 23, 24, 25, 26, 27, 28 or AC Outputs 22A, 23A, 24A with different voltages and currents after being transformed.

FIG. 1 and FIG. 2 illustrate one embodiment of the invention. The transformation socket in this embodiment includes the DC power input 21 and the DC outputs 22, 23, 24, 25, 26, 27, 28 disposed on its circuit board 2.

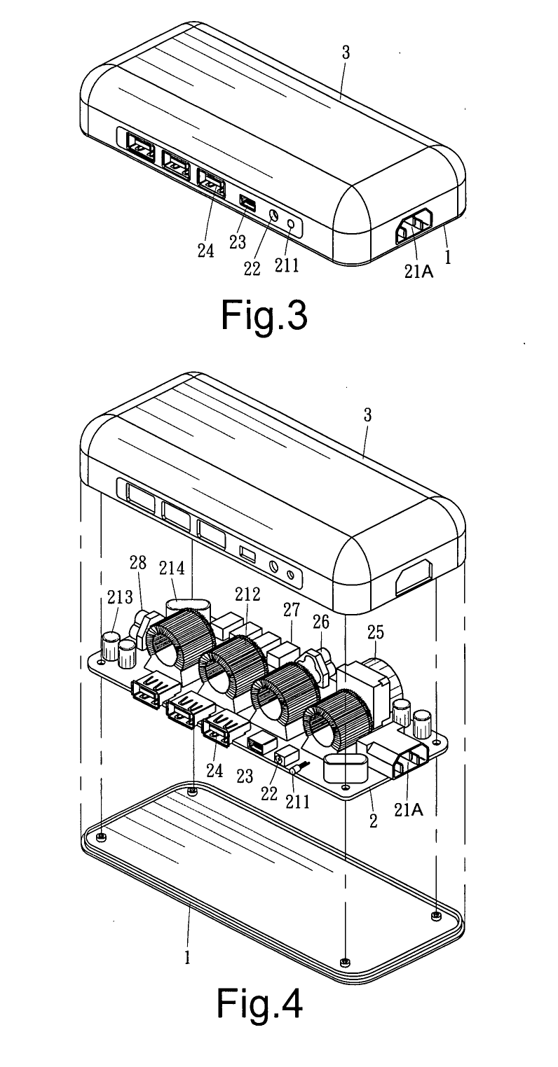

FIG. 3 and FIG. 4 illustrate another embodiment of the invention. The transformation socket in this embodiment includes the AC power input 21A and the DC outputs 22, 23, 24, 25, 26, 27, 28 disposed on its circuit board 2.

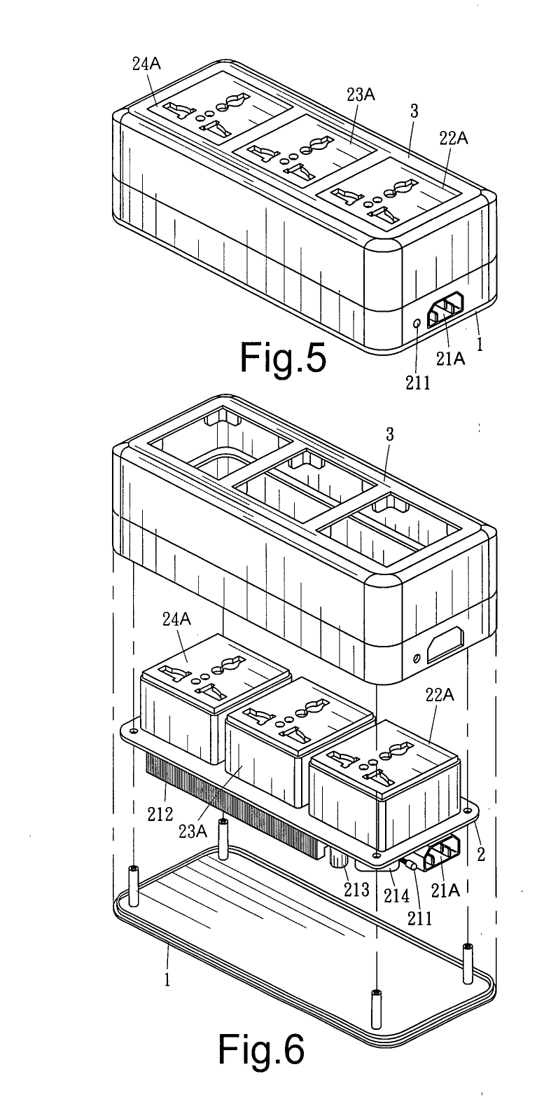

FIG. 5 and FIG. 6 illustrate still another embodiment of the invention. The transformation socket in this embodiment includes the AC power input 21A and the AC outputs 22A, 23A, 24A disposed on its circuit board 2.

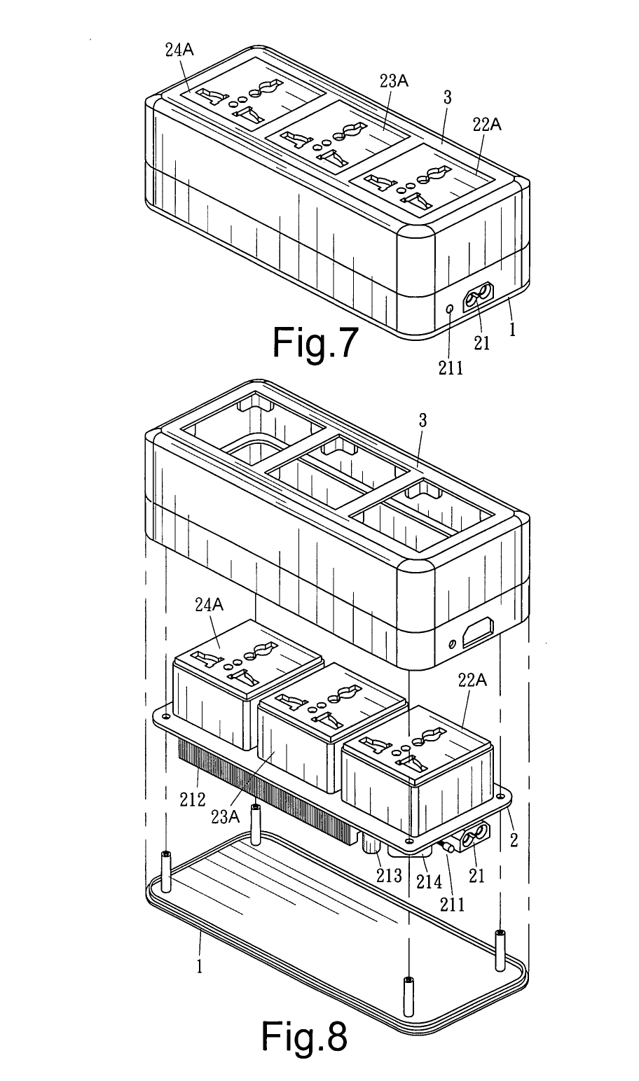

FIG. 7 and FIG. 8 illustrate yet another embodiment of the invention. The transformation socket in this embodiment includes the DC power input 21 and the AC outputs 22A, 23A, 24A disposed on its circuit board 2.

According to the aforementioned embodiments, the configuration of the external transformation sockets are characterized in that power may be input by the DC power input 21 or the AC power input 21A, depending on the DC or AC requirements for users, and in that power may be supplied and output by the DC outputs 22, 23, 24, 25, 26, 27, 28 or the AC outputs 22A, 23A, 24A of the socket, depending on the DC or AC requirements for users.

What is claimed is:

1. An external transformation socket excluding a power cord but including an AC or DC input and many groups of transformed AC or DC outputs, the functions of inputting, transforming and outputting include AC/AC, AC/DC, DC/DC, and DC/AC, the socket comprises a substrate 1, a circuit board 2 fixed on the substrate 1, and a top housing 3, wherein the circuit board 2 comprises a DC power input 21 or an AC power input 21A, an indicator 211, a transformation coil 212, a capacitor 213, a constant voltage regulator 214, and several DC outputs 22, 23, 24, 25, 26, 27, 28 or AC outputs 22A, 23A, 24A with different voltages and currents after being transformed, and thereby inputting power, depending on DC or AC requirements for users, and outputting power via the DC outputs or the AC outputs of the socket, depending on DC or AC requirements for users.
